(19) United States
(12) Patent Application Publication
(10) Pub. No.: US 2009/0263187 A1
(43) Pub. Date: Oct. 22, 2009

(54) QUICK RELEASE DEVICE FOR COVER OF NAILERS

(76) Inventor: YI-KUAN LEE, Ta-Li City (TW)

Correspondence Address: PHILLIP LIU, 6980, WHITEOAK DRIVE, RICHMOND, V7E4Z9, omitted

(21) Appl. No.: 12/426,137

(22) Filed: Apr. 17, 2009

(30) Foreign Application Priority Data
Apr. 18, 2008 (TW) 097206670

(51) Int. Cl. H01R 13/62

(52) U.S. Cl. 403/330

(57) ABSTRACT

A quick release device for nailers includes a barrel having a axial nail path and a cover is pivotably mounted to a top of the barrel and has two extensions which extend through the barrel and each extension has a hook and an opening which defines the hook corresponding thereto. A quick release unit has two walls which are cooperated with a spring and pivotably connected to the barrel. Each wall has an inclined surface and a contact surface. The two hooks contact the two inclined surfaces. The inclined surface and the aperture are located on the same side relative to the hook corresponding thereto. A top end of each inclined surface is located corresponding to the opening of the hook corresponding thereto. The cover is secured to the barrel even the nails jam and the cover can be easily opened by pivoting the quick release device.

### FIELD OF THE INVENTION

The present invention relates to a quick release device, and more particularly, to a quick release device for preventing the cover of a nailer from being loosened ad quickly releasing the cover when needed.

### BACKGROUND OF THE INVENTION

A conventional quick release device 2 for a nailer is shown in FIG. 1 is connected to the cover 18 which mounted on the barrel 10 and the barrel is connected to a positioning member 15 by bolts 19. The barrel 10 and the cover 18 is located at the front end of the nailer and the barrel 10 includes an axial nail path (not shown) and a feeding path (not shown) which is perpendicular to the nail path so that nails (not shown) can be fed into the axial nail path via the feeding path. Two hooks 11 are located on two sides of the axial nail path and extend through the cover 18. A from extend from the cover 18 and the quick release device 2 is pivotably connected to the frame by extending a pin 28 through holes 210 in the body 21 of the quick release device 2 and the frame. A positioning member 25 is a C-shaped member whose two ends are inserted into two positioning holes 211 in the body 21 and the positioning member 25 is hooked with the two hooks 11. A lever 212 is located at a rear end of the body 21. A distance is defined between the through holes 210 and the positioning holes 211. By pivoting the body 21 about the through holes 210, the positioning member 25 is pivoted about the positioning holes 211 so that the positioning member 25 is securely hooked with the hooks 11 to position the cover 18.

The connection between the cover 18 and the barrel 15 is loosened due to manufacturing tolerance and frequent impact when nailing, the gap between the barrel 15 and the cover 18 becomes larger and larger to cause nail deformation and jamming. The nail is stocked between the barrel 15 and the cover 18 so securely so that the user has to use a tool to loosen the cover to remove the deformed nail.

The present invention intends to provide a quick release device for nailer wherein the cover can be securely connected to the barrel by the quick release device so that the gap between the barrel and the cover is avoided from being increased, and the cover is able to be easily opened by operation of the quick release device.

### SUMMARY OF THE INVENTION

The present invention relates to a quick release device for nailers and comprises a barrel which includes an axial nail path and a feeding path which is perpendicular to the axial nail path. A cover is pivotably mounted to a top of the barrel and has two extensions extending from an underside thereof. The two extensions extend through the two slots and each have a hook and an opening which defines the hook corresponding thereto. The two extensions extend through two slots of the barrel. The quick release unit has two walls on two sides of a first end thereof and the two walls are pivotably connected to the barrel by extending a pin through the two through holes in the barrel and the two walls. The two walls each have a contact surface defined in an underside thereof and an inclined surface defined in a top thereof. A lever extends from a second end of the quick release device. A spring is mounted to the pin and two legs of the spring contact one of the contact surfaces and a side of the barrel. The lever projects beyond the barrel. The two hooks contact the two inclined surfaces, wherein the inclined surface and the aperture are located on the same side relative to the hook corresponding thereto. A top end of each inclined surface is located corresponding to the opening of the hook corresponding thereto.

The primary object of the present invention is to provide a quick release device for nailers wherein the cover is securely hooked by the quick release device when nail jams and the cover can also be easily opened by pivoting the quick release device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show a conventional quick release device on a nailer;

FIG. 2 is an exploded view to show the quick release device of the present invention;

FIG. 3 is a cross sectional view to show the connection of the quick release device of the present invention;

FIG. 4 is an enlarged cross sectional view to show that the hooks contact the inclined surfaces of the quick release device of the present invention;

FIG. 5 is an enlarged cross sectional view to show that cover is securely hooked when nail jam by the quick release device of the present invention;

FIG. 6 is an enlarged cross sectional view to show that cover is easily unhooked when pivoting the quick release device of the present invention;

FIG. 7 shows that the cover is opened as the sequence of the action in FIG. 6;

FIG. 8 is a cross sectional view to show another embodiment of the quick release device of the present invention, and

FIG. 9 is a cross sectional view to show yet another embodiment of the quick release device of the present invention.

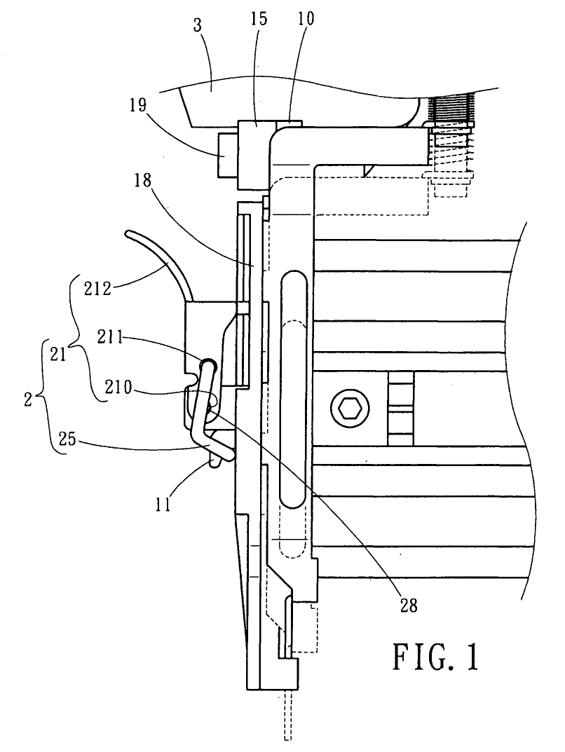

### DETAILED DESCRIPTION OF THE PREFERRED EMBODIMENT

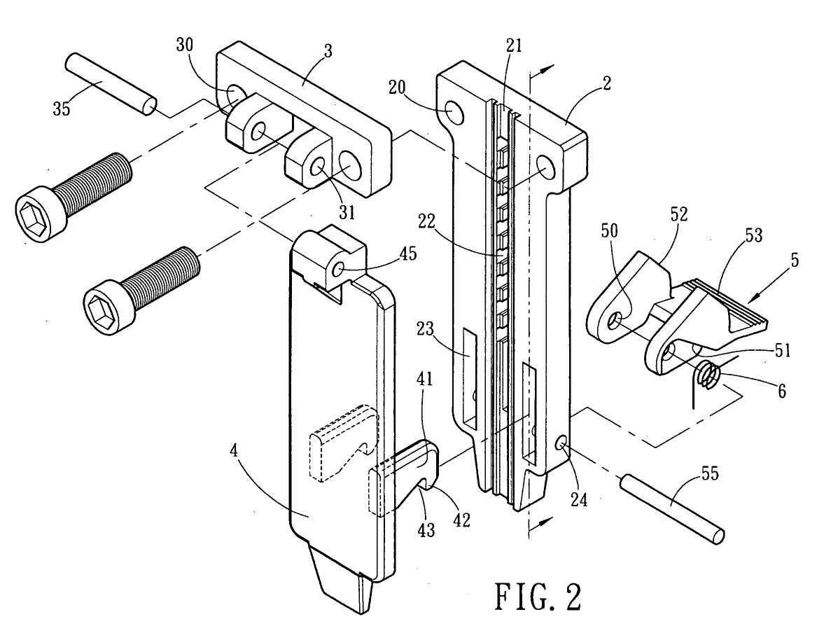

Referring to FIGS. 2 to 7, the quick release device of a nailer of the present invention comprises a barrel 2 which is connected to the front end of the nailer and has an axial nail path 21 defined in a top thereof so that nails (not shown) are supplied into the axial nail path 21 via a feeding path 22 defined through the barrel 2. The feeding path 22 is perpendicular to the axial nail path 21. Two slots 23 are defined through the barrel 2 and the axial nail path 21 is located between the two slots 23. Two through holes 24 are defined through two sides of the barrel 2 and communicate with the two slots 23. The barrel 2 includes two first connection holes 20 and a positioning member 3 includes two second connection holes 30 which are in alignment with the first connection holes 20 of the barrel 2. Two bolts extend through the aligned first and second connection holes 20, 30 to connect the positioning member 3 to the barrel 2. The positioning member 3 includes first connection portions 31 and the first connection portions 31 of the positioning member 3 are two lugs.

A cover 4 includes a second connection portion 45 which is pivotably connected to the first connection portions 31 by a pin 35. The cover 4 is pivotably mounted to a top of the barrel 2 and has two extensions 41 extending from an underside thereof. The two extensions 41 extend through the two slots 23 and each have a hook 42 and an opening 43 which defines the hook 42 corresponding thereto.

A quick release unit 5 has two walls on two sides of a first end thereof and two apertures 50 are defined through the two walls. Two contact surfaces 51 are defined in two respective undersides of the two walls and two inclined surfaces 52 are defined in two respective tops of the two walls. A lever 53 extends from a second end of the quick release unit 5. Each inclined surface 52 declines from the opening 43/27 toward the lever 53. A pin 55 extends a torsion spring 6, the two through holes 24 of the barrel 2 and the two apertures 50 of the quick release unit 5. Two legs of the spring 6 contact one of the contact surfaces 51 and a side of the barrel 2. The lever 53 projects beyond the barrel 2.

The two hooks 42 contact the two inclined surfaces 52, wherein the inclined surface 52 and the aperture 50 are located on the same side relative to the hook 42 corresponding thereto. A top end of each inclined surface 52 is located corresponding to the opening 43 of the hook 42 corresponding thereto. The top end of each inclined surface 52 is located between the opening 27 and the aperture 50 corresponding thereto. A distance between the top end of the inclined surface 52 to the aperture 50 is shorter than a distance from a bottom end of the inclined surface 52 to the aperture 50.

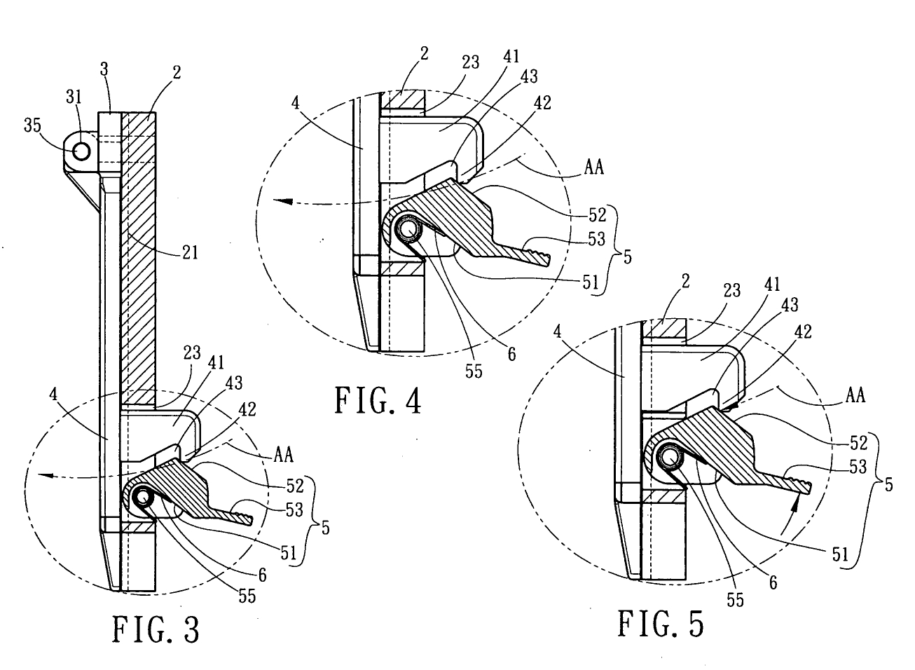

As shown in FIGS. 3 to 5, when the nails jam, the cover 4 is applied by an impact and tends to move away from the barrel 2, so that the hooks 42 apply a force along line AA which exerts a component force to the inclined surfaces 52 and tends to rotate the quick release unit 5 counter clockwise about the pin 55. This makes the inclined surfaces 52 not be separated from the hooks 42 so that the more the force that the jamming nails apply to the cover 4, the securer that the hooks 42 are connected with the quick release unit 5.

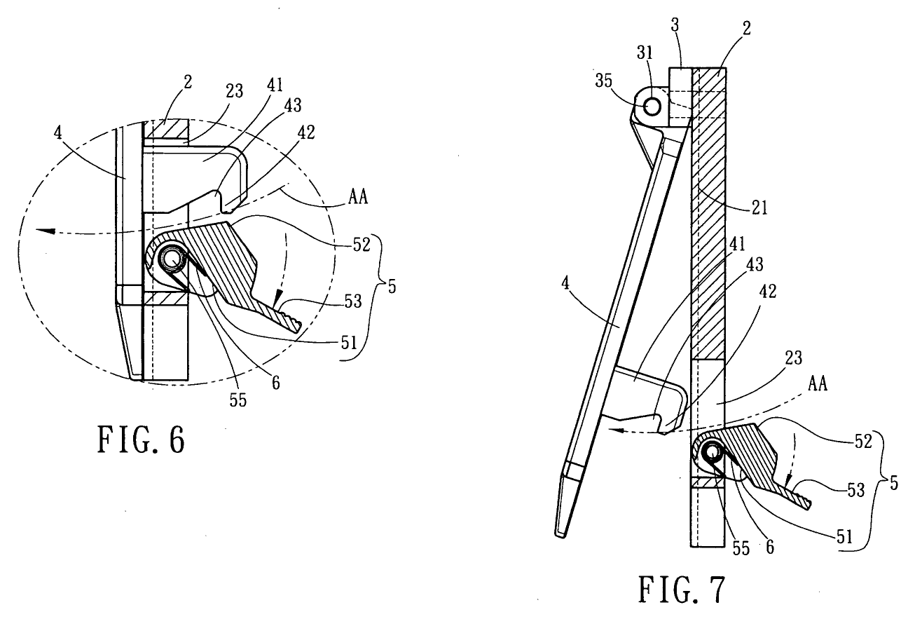

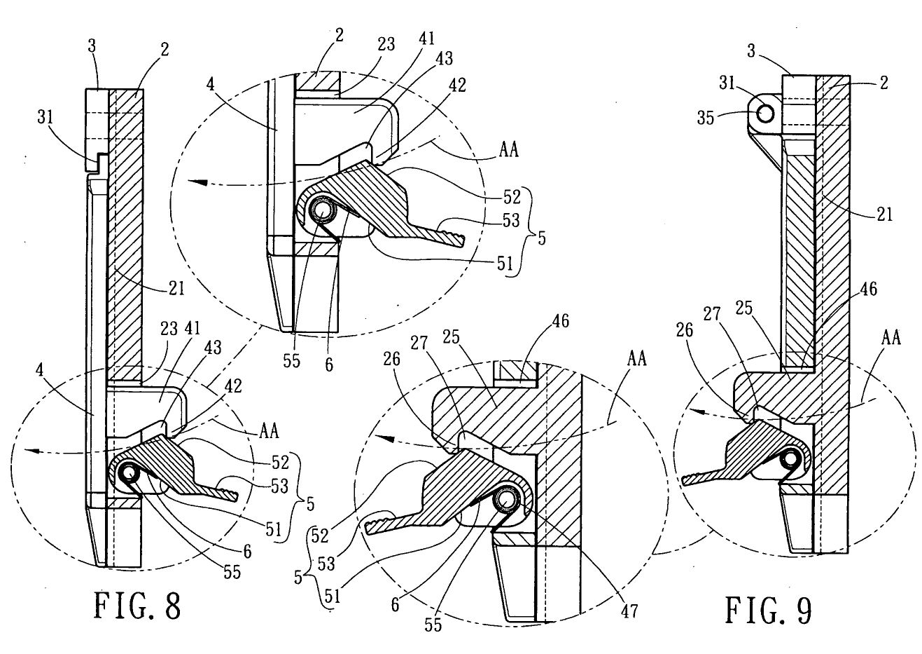

On the contrary, as shown in FIGS. 6 and 7, the user can easily pivot the lever 53 clockwise, because the distance from the lever 53 to the apertures 50 is longer than the distance from the inclined surfaces 52 to the through holes 50, so that the quick release unit 5 can be easily pivoted to separated from the hooks 42. The cover 4 is then opened to remove the jammed nails. FIG. 8 shows another embodiment of the connection between the positioning member 3 and the cover 4, wherein the cover 4 is slid and then opened.

FIG. 9 shows that the extensions 41 on the cover 4 of the first embodiment as shown in FIG. 2 can be omitted, and the barrel 2 has an axial nail path 21 defined in a top thereof and a feeding path 22 is defined through the barrel 2 and perpendicular to the axial nail path 21. Two protrusions 25 extend from the barrel 2 and each protrusion 25 has a hook 26 and an opening 27 defines the hook 26.

The cover 4 is pivotably mounted to a top of the barrel 2 and has two slots 46 through which the protrusions 25 of the barrel 2 extend. Two through holes 47 are defined in the cover 4 and communicate with eth slots 46.

The quick release unit 5 is the same as that shown in FIG. 2 and is pivotably connected to the cover 4 by the pin 55 which extends the spring 6, the two through holes 47 of the cover 4 and the two apertures 50 of the quick release unit 5. The two legs of the spring 6 contact one of the contact surfaces 51 and a side of the cover 4. The lever 53 projects beyond the cover 4. The two hooks 26 contact the two inclined surfaces 52, the inclined surface 52 and the aperture 50 are located on the same side relative to the hook 26 corresponding thereto. The top end of each inclined surface 52 is located corresponding to the opening 27 of the hook 26 corresponding thereto. The top end of each inclined surface 52 is located between the opening 27 and the aperture 50 corresponding thereto. Each inclined surface 52 declines from the opening 27 toward the lever 53. The distance between the top end of the inclined surface 52 to the aperture 50 is shorter than a distance from a bottom end of the inclined surface 52 to the aperture 50. The positioning member 3 includes two second connection holes 30 which are in alignment with the first connection holes 20 of the barrel 2. Two bolts extend through the aligned first and second connection holes 20, 30 to connect the positioning member 3 to the barrel 2. The positioning member 3 includes first connection portions 31 and the cover 4 is pivotably connected to the first connection portions 31. The first connection portions 31 of the positioning member 3 are two lugs and the pin 35 extends through the two lugs and the second connection portion 45 of the cover 4.

While we have shown and described the embodiment in accordance with the present invention, it should be clear to those skilled in the art that further embodiments may be made without departing from the scope of the present invention.

What is claimed is:

1. A quick release device for nailers, comprising:
a barrel having an axial nail path defined in a top thereof and a feeding path defined through the barrel and being perpendicular to the axial nail path, two slots defined through the barrel and the axial nail path located between the two slots, two through holes defined through two sides of the barrel and communicating with the two slots;
a cover pivotably mounted to a top of the barrel and having two extensions extending from an underside thereof, the two extensions extending through the two slots and each having a hook and an opening which defines the hook corresponding thereto, and
a quick release unit having two walls on two sides of a first end thereof and two apertures defined through the two walls, two contact surfaces defined in two respective undersides of the two walls and two inclined surfaces defined in two respective tops of the two walls, a lever extending from a second end of the quick release unit, a pin extending a spring, the two through holes of the barrel and the two apertures of the quick release unit, two legs of the spring contacting one of the contact surfaces and a side of the barrel, the lever projecting beyond the barrel, the two hooks contacting the two inclined surfaces, the inclined surface and the aperture located on the same side relative to the hook corresponding thereto, a top end of each inclined surface located corresponding to the opening of the hook corresponding thereto.

2. A quick release device for nailers, comprising:
a barrel having an axial nail path defined in a top thereof and a feeding path defined through the barrel and being perpendicular to the axial nail path, two protrusions extending from the barrel and each protrusion having a hook and an opening defining the hook;
a cover pivotably mounted to a top of the barrel and having two slots through which the protrusions of the barrel extend, through holes defined in the cover, and
a quick release unit having two walls on two sides of a first end thereof and two apertures defined through the two walls, two contact surfaces defined in two respective undersides of the two walls and two inclined surfaces defined in two respective tops of the two walls, a lever extending from a second end of the quick release unit, a pin extending a spring, the two through holes of the cover and the two apertures of the quick release unit, two legs of the spring contacting one of the contact surfaces and a side of the cover, the lever projecting beyond the cover, the two hooks contacting the two inclined surfaces, the inclined surface and the aperture located on the same side relative to the hook corresponding thereto, a top end of each inclined surface located corresponding to the opening of the hook corresponding thereto.

3. The device as claimed in claim 1, wherein the top end of each inclined surface is located between the opening and the aperture corresponding thereto.

4. The device as claimed in claim 3, wherein each inclined surface declines from the opening toward the lever.

5. The device as claimed in claim 3, wherein a distance between the top end of the inclined surface to the aperture is shorter than a distance from a bottom end of the inclined surface to the aperture.

6. The device as claimed in claim 4, wherein the barrel includes two first connection holes and two bolts extend through the first connection holes so that the barrel is adapted to be connected to the nailer.

7. The device as claimed in claim 6, wherein a positioning member includes two second connection holes which are in alignment with the first connection holes of the barrel, the two bolts extend through the aligned first and second connection holes, to connect the positioning member to the barrel, the positioning member includes first connection portions and the cover is pivotably connected to the first connection portions.

8. The device as claimed in claim 7, wherein the first connection portions of the positioning member are two lugs and a pin extends through the two lugs and the cover.

9. The device as claimed in claim 7, wherein the cover includes a second connection portion which is pivotably connected to the first connection portions.
